(19) United States
(12) Patent Application Publication
(10) Pub. No.: US 2009/0051887 A1
(43) Pub. Date: Feb. 26, 2009

(54) Projector and cover plate thereof

(75) Inventors: Chia-Tien Chen, Hsinchu (TW); Hung-Lin Lee, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/153,913

(22) Filed: May 28, 2008

(30) Foreign Application Priority Data
Aug. 24, 2007 (TW) 096131350

(51) Int. Cl. G03B 21/14

(52) U.S. Cl. 353/119

(57) ABSTRACT

A projector and a cover plate thereof are disclosed. The cover plate includes a main lid, a pivot member and an auxiliary lid. The main lid has a lock portion and a window portion. The auxiliary lid has a side connecting to the pivot member. By means of the pivot member, the auxiliary lid is capable of being opened by lifting relative to the main lid, so as to cover the window portion selectively. In addition, the auxiliary lid has a hook member disposed at a position corresponding to the lock portion. Therefore, when the auxiliary lid covers the window portion, it is capable of being moved parallel and relative to the main lid by means of the pivot member, and the hook member is locked by the lock portion selectively.

### BACKGROUND OF THE INVENTION

(1) Field of the Invention

The present invention relates to a projector with a cover plate, and more particularly to a cover plate which is capable of being opened by lifting and a projector having the same.

(2) Description of the Prior Art

The fault of a projector is mainly caused by its lamp. Therefore, a case of the projector usually provides a lamp cover for users to change the lamp. The lamp cover of the conventional projector is locked to the case by screws, or fixed to the case by hook members cooperating with screws.

FIG. 1A shows a projector 100 which has a conventional lamp cover 102. The conventional lamp cover 102 is assembled on a top cover 104 of a case of the projector 100, and used to cover a window portion 106. The window portion 106 is disposed on the top cover 104 for users to adjust, repair or change the lamp (not shown) inside the projector 100. The lamp cover 102 and the top cover 104 respectively have threaded holes 108 and 109, for using to lock together with each other.

Referring to FIG. 1B, a hook member 107 is disposed on a bottom of the lamp cover 102, and corresponds to a lock portion such as a protruding rail 105 of the top cover 104. Referring to FIG. 1A, when the lamp cover 102 is moved to the left and closed, the hook member 107 is also moved left to prop the protruding rail 105 at the same time. Then screws (not shown) are placed into the threaded holes 108 and 109. Thereby, the lamp cover 102 is assembled to the top cover 104. On the contrary, when the lamp cover 102 needs to be opened, screws are torn down, then the lamp cover 102 are pull to the right, while the hook member 107 is moved to the right so as to separate from the protruding rail 105.

The drawback of above mentioned structure is that the screws need to be torn down before opening the lamp cover 102, which results in inconvenient to repair the projector. Specially, it is apparently inconvenient to repair a C-mount type projector which is fixed on the ceiling.

### SUMMARY OF THE INVENTION

The invention is to provide a cover plate of a projector, which is capable of being lifted for opening the projector and makes repair more conveniently.

For one or part of or all objectives mentioned or other objectives, one embodiment of the present invention provides a cover plate of a projector which includes a main lid having a lock portion and a window portion; a pivot member connected with the main lid; and an auxiliary lid having a side portion connected to the pivot member. The auxiliary lid is capable of being lifted relative to the main lid by means of the pivot member, so as to cover the window portion selectively. The auxiliary lid has a hook member disposed at a position corresponding to the lock portion. When the auxiliary lid covers the window portion, it has a displacement parallel and relative to the main lid by means of the pivot member. Thereby, the hook member is locked by the lock portion selectively.

Another embodiment of the present invention provides a projector, which includes a light emitting element; a case for placing the light emitting element; a main lid assembled with the case, and having a lock portion and a window portion which is disposed at a corresponding position to the light emitting element; a pivot member connected with the main lid; and an auxiliary lid having a side connected to the pivot member. The auxiliary lid is lifted relative to the main lid by means of the pivot member, so as to cover the window portion selectively. The auxiliary lid has a hook member disposed at a position corresponding to the lock portion. When the auxiliary lid covers the window portion, it has a displacement parallel and relative to the main lid by means of the pivot member. Thereby, the hook member is locked by the lock portion selectively.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will now be specified with reference to its preferred embodiment illustrated in the drawings, in which

FIG. 1A is the schematic view of a projector having a conventional cover plate;

FIG. 1B is the schematic view showing a hook member which is disposed on the bottom of the conventional cover plate;

FIG. 2A and FIG. 2B are the schematic views showing a projector and the motion of its cover plate for opening and closing according to one embodiment of the present invention;

FIG. 3A and FIG. 3B are the schematic views showing the buckling of a pivot member according to one embodiment of the present invention;

FIG. 3C is the schematic view showing the locking of the cover plate via a hook member and a lock portion according to one embodiment of the present invention;

FIG. 4A is the schematic view showing a part of the cover plate with a base, a structure for preventing the auxiliary lid from excessive overturn and a stop structure according to one embodiment of the present invention;

FIG. 4B is the top schematic view showing a structure for preventing the auxiliary lid from excessive overturn and a stop structure of the cover plate according to one embodiment of the present invention;

FIG. 4C is the bottom schematic view showing a structure for preventing the auxiliary lid from excessive overturn and a stop structure of the cover plate according to one embodiment of the present invention;

FIG. 5A is the schematic view showing a locating structure of the cover plate according to one embodiment of the present invention;

FIG. 5B and FIG. 5C are the schematic views showing a molding of the cover plate according to one embodiment of the present invention;

FIG. 6 is the bottom schematic view showing a part of the closed cover plate according to one embodiment of the present invention; and

FIG. 7 is the schematic view showing a C-mount projector according to one embodiment of the present invention.

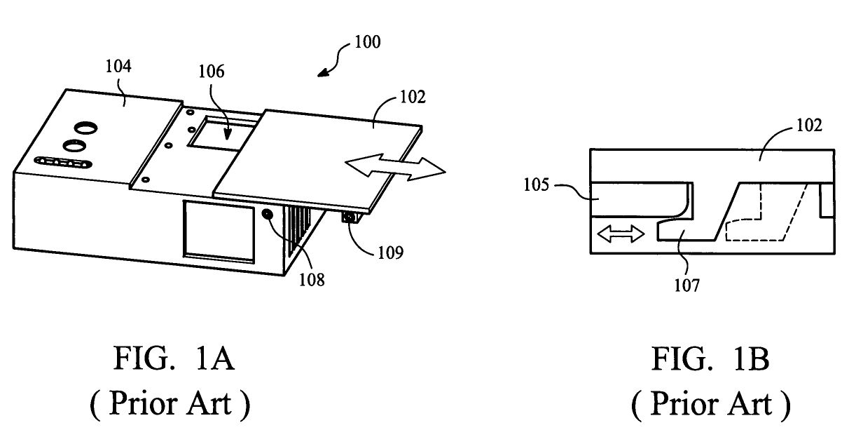

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

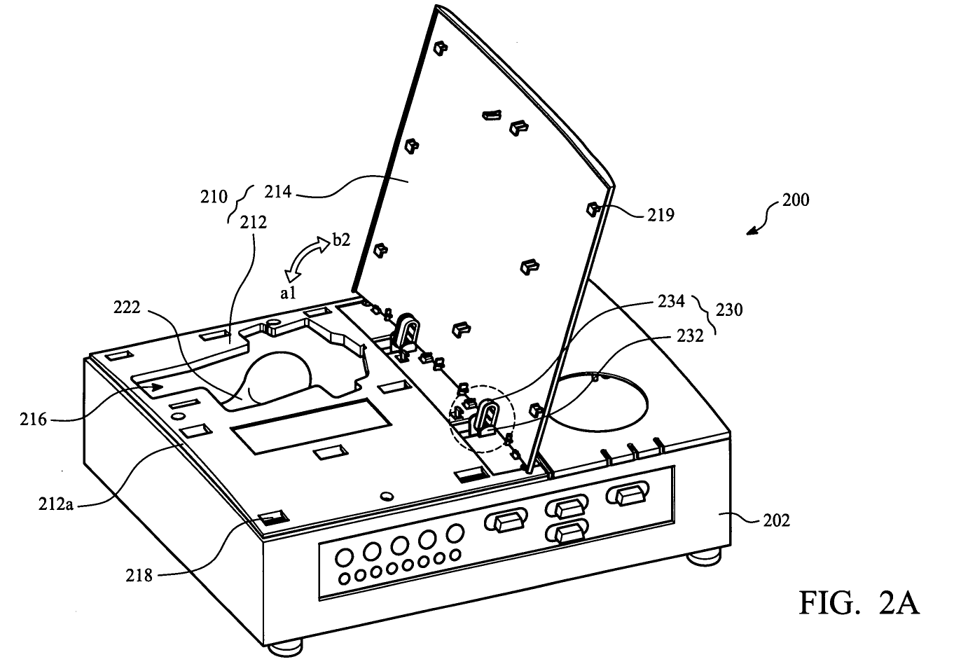

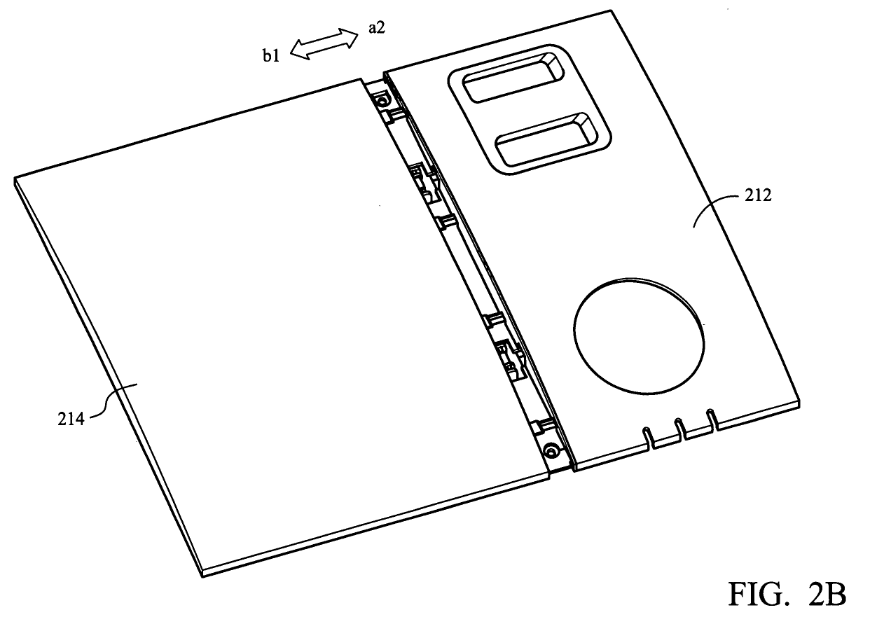

FIG. 2A shows that a projector 200 includes a cover plate 210 according to one preferred embodiment of the present invention. The projector 200 includes a case 202 for placing a projection mechanism (not shown). The projection mechanism includes a light emitting element such as a lamp 222 or a light emitting diode (LED), and a light engine (not shown) etc. The cover plate 210 is assembled on the case 202 to cover the projection mechanism. As shown, the cover plate 210 includes a main lid 212 and an auxiliary lid 214 (also referred to as lamp cover), and is assembled with the case 202 by means of the main lid 212.

The main lid 212 and the auxiliary lid 214 are assembled together through a pivot member 230. As shown in FIG. 2A, the pivot member 230 includes a base 232 disposed on the main lid 212, and a hollow retaining ring 234 disposed on the auxiliary lid 214. The hollow retaining ring 234 is movably fastened to the base 232. Thereby, the hollow retaining ring 234 is capable of rotating relative to the base 232, and a part of the base 232 is located in the hollow retaining ring 234 and capable of moving relative to the hollow retaining ring 234. Therefore, the auxiliary lid 214 is capable of being lifted up from or closed toward the main lid 212 as shown by arrow b2 or a1.

The main lid 212 has a window portion 216 and a lock portion 218. When the main lid 212 is assembled with the case 202, the window portion 216 is located on the lamp 222 for exposing the lamp 222. When the auxiliary lid 214 is closed toward the main lid 212, it is capable of covering the window portion 216 and the lamp 222 located below the window portion 216. For preventing the closed auxiliary lid 214 from lifting up easily, the auxiliary lid 214 provides a hook member 219 disposed at a position corresponding to the lock portion 218 to be locked by the lock portion 218 easily. When the lamp 222 fails or needs to be adjusted, users open the auxiliary lid 214 without tools like screwdriver, so that the projector 200 is more conveniently to be repaired. For that, the size of the window portion 216 is enough for user to take out the lamp 222.

FIG. 2A and FIG. 2B are the schematic views showing the motion of the auxiliary lid 214 for lifting up or closing. When users want to open the auxiliary lid 214, they first should pull the auxiliary lid 214 horizontally, so that the auxiliary lid 214 has a displacement parallel and relative to the main lid 212 along the direction b1 shown in FIG. 2B, and then lift along the direction b2 shown in FIG. 2A. On the contrary, when users want to close the auxiliary lid 214, they first should close the auxiliary lid 214 along the direction a1 shown in FIG. 2A, and then make it move parallel and relative to the main lid 212 along the direction a2 shown in FIG. 2B, so that the auxiliary lid 214 is closed horizontally. In the embodiment, the hook member 219 is locked by the lock portion 218 selectively.

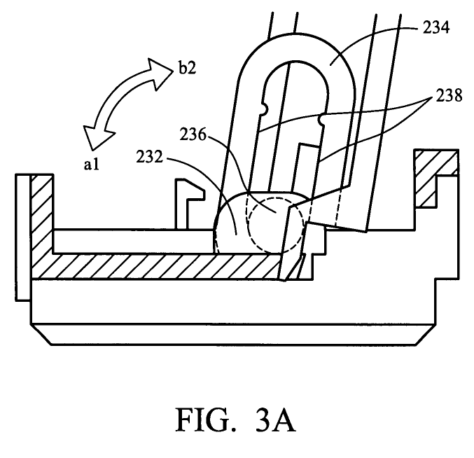

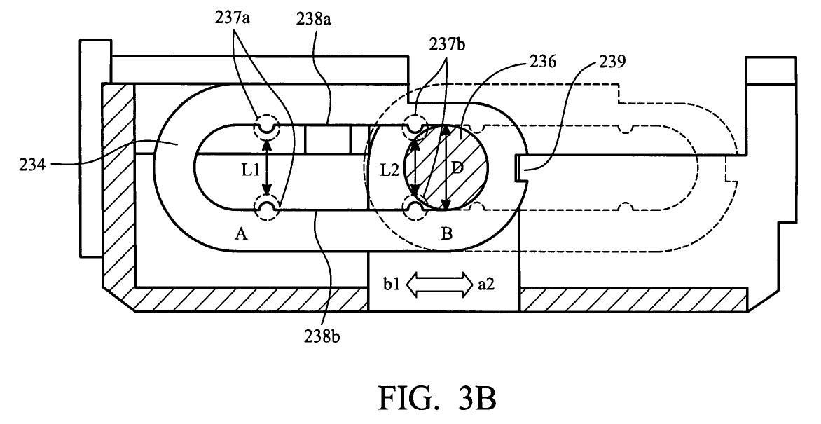

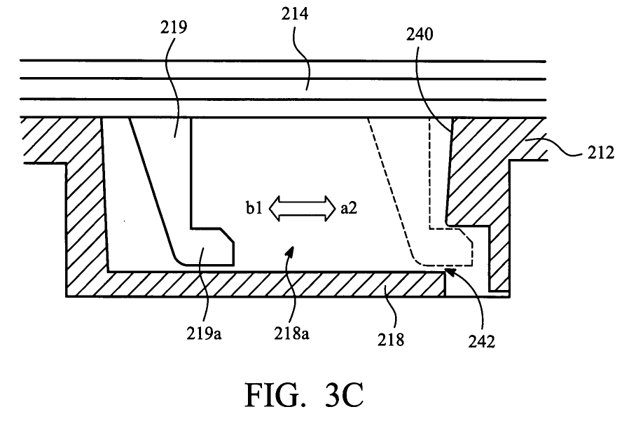

Referring to FIG. 3A and FIG. 3B, the base 232 has a shaft 236 disposed therein. The hollow portion of the hollow retaining ring 234 is formed as a rail structure 238. When the hollow retaining ring 234 is buckled with the base 232, the shaft 236 is pushed through the rail structure 238. The shaft 236 is capable of moving relative to the rail structure 238 along the extension direction of the rail structure 238, while the hollow retaining ring 234 rotates with the shaft 236 as a center.

The rail structure 238 of the hollow retaining ring 234 has two inside walls 238a and 238b opposite to and substantially parallel to each other, a pair of first protruding points 237a and a pair of second protruding points 237b. Each of the first protruding points 237a respectively protrudes from the different inside wall 238a or 238b. Each of the first protruding points 237a also respectively protrudes from the different inside wall 238a or 238b. When the shaft 236 moves in the rail structure 238, it is fixed and located at point A by the pair of first protruding points 237a, or fixed and located at point B by the pair of second protruding points 237b. For the purpose of locating, the distance L1 between the pair of first protruding points 237a is smaller than a diameter D of the shaft 236, while the distance L2 between the pair of second protruding points 237b is also smaller than the diameter D of the shaft 236.

In another preferred embodiment of the present invention, the base 232 is fixed to the main lid 212 or is formed integrally with the main lid 212, and the hollow retaining ring 234 is fixed at a side portion of the auxiliary lid 214. Thus, the base 232 accompanies the main lid 212 to be fixed on the case 202. The hollow retaining ring 234 moves or rotates as the auxiliary lid 214 is in motion.

FIG. 3A and FIG. 3B is used to illustrate the relative motion between the base 232 and the hollow retaining ring 234 during lifting or covering the auxiliary lid 214. FIG. 3C is used to illustrate the relative motion between the hook member 219 and the lock portion 218. Referring to FIG. 2A and FIG. 3A, when the auxiliary lid 214 is opened, the hollow retaining ring 234 is erect substantially. When users cover the auxiliary lid 214 along the direction a1, the hollow retaining ring 234 topples down as shown in FIG. 3B. Referring to FIG. 2B and FIG. 3B, when users push the auxiliary lid 214 along the direction a2, the hollow retaining ring 234 moves horizontally along the direction a2, which makes the shaft 236 of the base 232 move from position B to position A. On the contrary, if the auxiliary lid 214 is opening, then the relative motion between the shaft 236 and the hollow retaining ring 234 is along a direction opposite to the above mentioned direction.

FIG. 3C is a cross-sectional view of the lock portion 218 and the hook member 219. The hook member 219 protrudes from the surface of the auxiliary lid 214, and has an L-shaped bending 219a. The lock portion 218 has a trough structure 218a which caves in the surface of the main lid 212. The trough structure 218a is shown as oblique line. A sidewall 240 of the trough structure 218a has a split 242 which is located at the connection portion between the sidewall 240 and the bottom of the trough structure 218a. When the auxiliary lid 214 is turned to cover the window portion 16 of the main lid 212, the hook member 219 is inserted into the trough structure 218a of the lock portion 218. Subsequently, the L-shaped bending 219a of the hook member 219 is pushed into the split 242 for locking when the auxiliary lid 214 is pushed along the direction a2 to close to the main lid 212

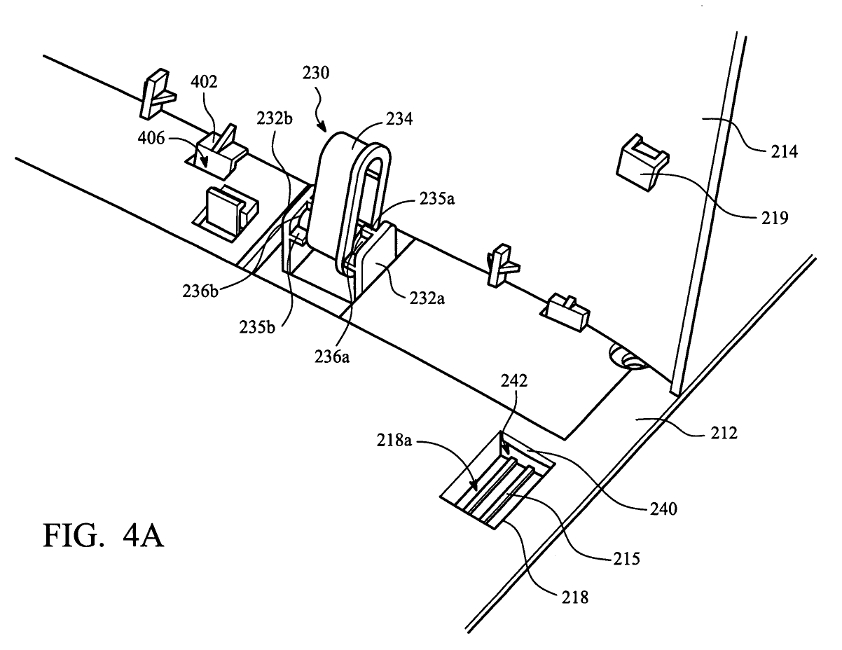

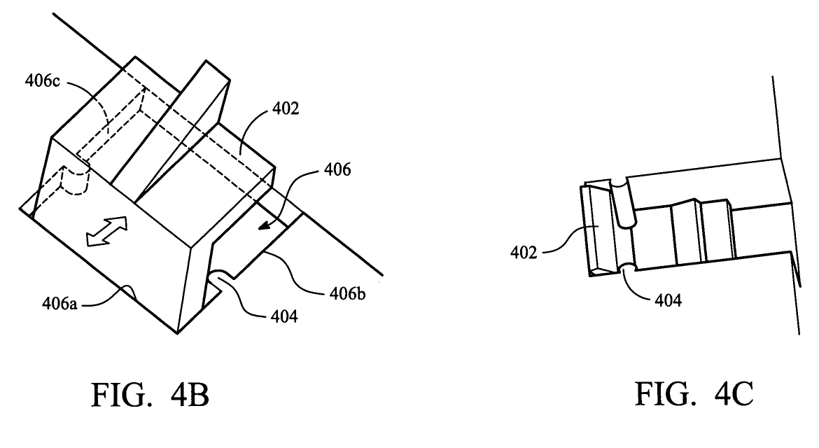

Referring FIG. 4A, the base 232 has a right support 232a and a left support 232b. A shaft 236a and a shaft 236b protrude at the inner side of the two supports 232a and 232b, respectively. There is a space between the two shafts 236a and 236b for the hollow retaining ring 234 to place in. Referring to FIG. 3B, one end of the hollow retaining ring 234 has an trench 239. And referring to FIG. 4A, when the hollow retaining ring 234 is placed from up to down between two shafts 236a and 236b, the trenches (not shown in FIG. 4A) are located at two sides of the bottom of the hollow retaining ring 234, and face respectively two shafts 236a and 236b. During the process of buckling, the shafts 236a and 236b are led into the hollow retaining ring 234 by the trench 239, so the bulking is easier done. There are a plurality of ribs 235a and 235b disposed on the surface of the shaft 236a or 236b. When the shaft 236a or 236b is buckled into the hollow retaining ring 234, the ribs 235a and 235b prop up the hollow retaining ring 234 slightly to avoid shaking, so the ribs 235a and 235b have function to enhance the strength of the structure. In addition, as shown in FIG. 4A, the trough structure 218a has a protruding rail 215 at the bottom thereof to buffer the impact force generated when the hook member is locked to the lock portion. The cover plate 210 has a structure for preventing the auxiliary lid 214 from excessive overturn, whose top view and bottom view are shown in FIG. 4B and FIG. 4C. An opening 406 is disposed in the main lid 212, and located at a side of the base 232 for a protrusion 402 to pass through. The protrusion 402 is disposed on the auxiliary lid 214 and is formed as L-shaped bending. When the auxiliary lid 214 is opened by lifting up and is substantially vertical to the main lid 212 (as shown in FIG. 2A), the protrusion 402 touches the wall 406a of the opening 406. At that time, if users apply a extra-force to the auxiliary lid 214 along the direction b2 shown in FIG. 2A, then the wall 406a applies a reacting force to the protrusion 402 to avoid the excessive overturn of the auxiliary lid 214.

FIG. 4B and FIG. 4C show that the cover plate 210 has a stop structure to prevent the opened auxiliary lid 214 from closing back. Two sidewalls 406b and 406c of the opening 406 respectively have a stop piece 404 which protrudes toward the inside of the opening 406. As above mentioned, if the opened auxiliary lid 214 trends to close back, the protrusion 402 is led to move to touch the stop piece 402. At that time, the stop piece 404 is capable of stopping the movement of the protrusion 402 to prevent the auxiliary lid 214 from closing back. Thereby, the space for the movement of the protrusion 402 is limited between the stop body 404 and the wall 406a of the opening 406.

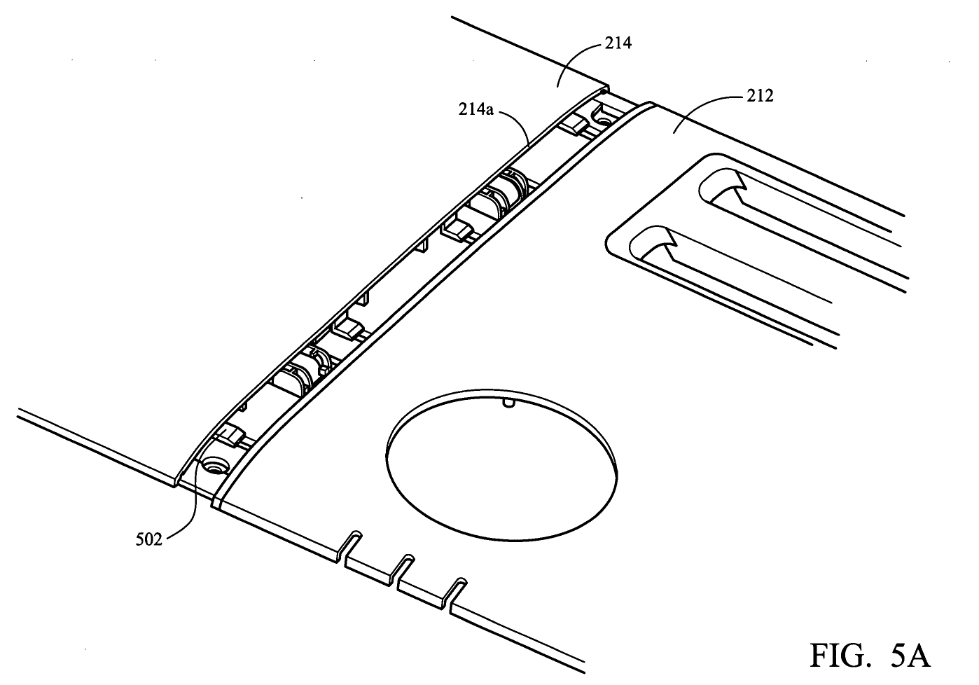

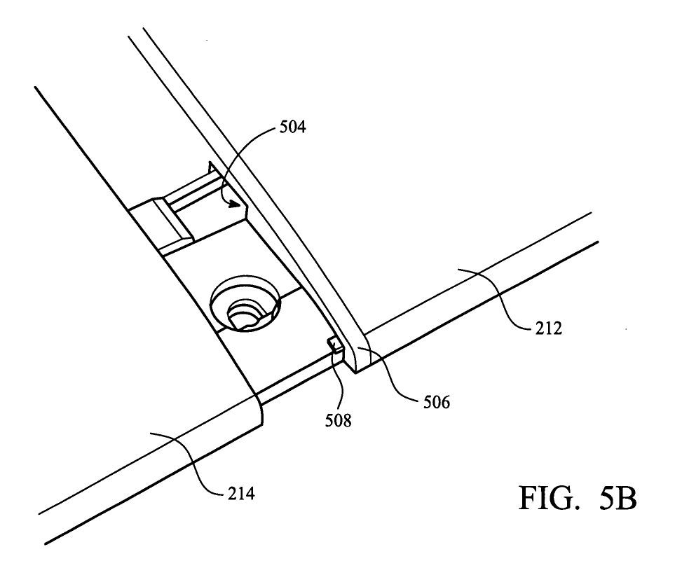

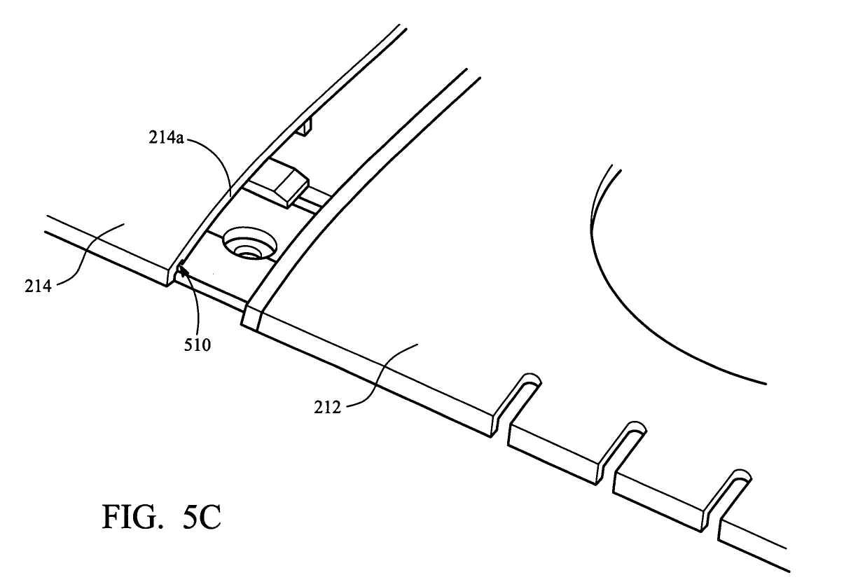

Referring to FIG. 5A and FIG. 5B, the auxiliary lid 214 has a locating piece 502 which protrudes from the edge 214a of auxiliary lid 214. The main lid 212 has a locating hole 504 for the locating piece 502 to plug in along the direction parallel to the surface of the main lid 212, which is capable of preventing the closed auxiliary lid 214 from vibration in an up-down or a lift-right direction.

Referring to FIG. 5B and FIG. 5C, a molding 506 is disposed on the main lid 212 to decorate the seam between the main lid 212 and the auxiliary lid 214. Specially, the molding 506 has a protrusion 508, and the edge 214a of the auxiliary lid 214 provides a breach 510. When the locating piece 502 is inserted into the locating hole 504, the protrusion 508 is inserted into the breach 510 to prevent the molding 506 from deflection.

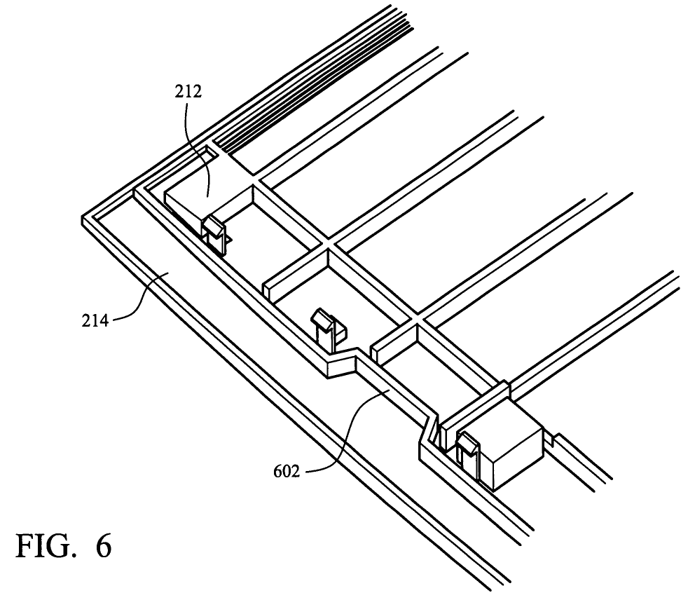

FIG. 6 is a bottom view sketch of a part of the cover plate 210 when the auxiliary lid 214 is closed. Referring to FIG. 2A, an edge 212a of the main lid 212 adds a concave portion 602. The concave portion 602 and the base 232 are respectively disposed at two opposite sides of the window portion 210. When the auxiliary lid 214 is closed, the concave portion 602 of the main lid 212 is capable of providing users to place their fingers, so as to hold the edge of the auxiliary lid 214 and apply a force to pull the auxiliary lid 214 open.

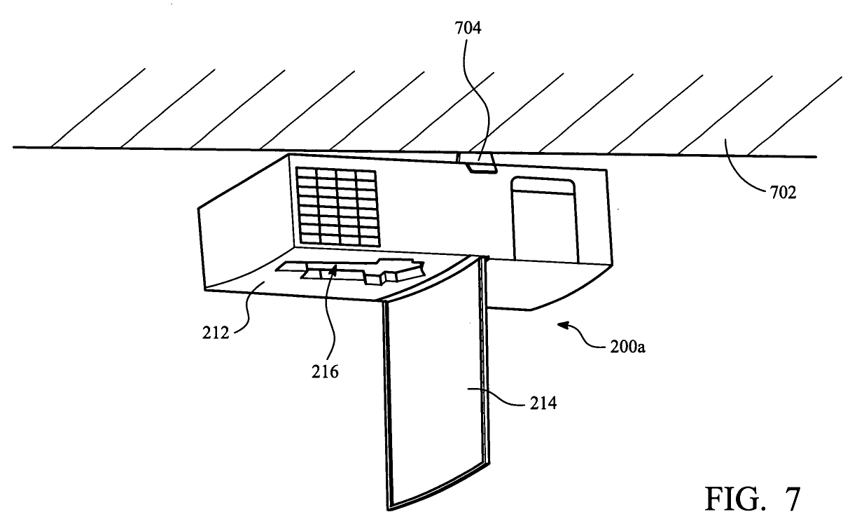

Referring to FIG. 7, a C-mount type projector 200a is suspended from a ceiling 702. The projector 200a has a fixed member 704 disposed on a surface of the case which is located at the rear of the main lid 212, for fixing the projector 200a to the ceiling 702. It is the outstanding advantages of the cover plate 210 to make the projector more easy to repair.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A cover plate of a projector, comprising:
a main lid, having a lock portion and a window portion;
a pivot member, connected with the main lid; and
an auxiliary lid, having a side portion connected to the pivot member, wherein the auxiliary lid is opened by lifting relative to the main lid by means of the pivot member, so as to cover the window portion selectively, and the auxiliary lid has a hook member disposed at a position corresponding to the lock portion and has a displacement parallel and relative to the main lid by means of the pivot member when the auxiliary lid covers the window portion, so that the hook member is locked by the lock portion selectively.

2. The cover plate of the projector of claim 1, wherein the pivot member includes a base and a hollow retaining ring, respectively connected to the main lid and the auxiliary lid, the base has a shaft which is movably fastened to the hollow retaining ring.

3. The cover plate of the projector of claim 2, wherein the base is fixed at a side of the window portion, and the hollow retaining ring is fixed at the side portion of the auxiliary lid.

4. The cover plate of the projector of claim 3, wherein the main lid provides an opening located at a side of the base, and the auxiliary further has a protrusion passing through the opening, the protrusion is moved to touch a first wall of the opening when the auxiliary lid is lifted and until substantially vertical to the main lid.

5. The cover plate of the projector of claim 4, wherein a second wall of the opening is formed as a stop piece, which protrudes toward an inside of the opening, and the protrusion is limited to move between the stop piece and the first wall of the opening when the auxiliary lid is lifted until substantially vertical to the main lid.

6. The cover plate of the projector of claim 2, wherein the hollow retaining ring has a rail structure, which includes a first protruding point and a second protruding point, so that the shaft is capable of moving in the rail structure, and is fixed at a first position by the first protruding point, or fixed at a second position by the second protruding point.

7. The cover plate of the projector of claim 6, wherein the rail structure has two opposite inside walls, which have two opposite first protruding points and two opposite second protruding points, each of the first protruding points is protruded on one of the opposite inside walls, and each of the second protruding points is protruded on one of the opposite inside walls.

8. The cover plate of the projector of claim 7, wherein a distance between the two opposite first protruding points is smaller than a diameter of the shaft, and a distance between the two opposite second protruding points is smaller than a diameter of the shaft.

9. The cover plate of the projector of claim 2, wherein a surface of the shaft has a plurality of ribs.

10. The cover plate of the projector of claim 2, wherein the main lid provides a concave portion located at an edge thereof, and the concave portion and the base are respectively disposed at two opposite sides of the window portion.

11. The cover plate of the projector of claim 2, wherein one end of the hollow retaining ring has a trench.

12. The cover plate of the projector of claim 1, wherein the auxiliary lid has a locating piece protruding from an edge thereof, and the main lid has a locating hole for the locating piece inserting along a direction parallel to a surface of the main lid.

13. The cover plate of the projector of claim 12, wherein the main lid further includes a molding corresponding to the edge of the auxiliary lid, two ends of the molding respectively have a protrusion, and two ends of the edge of the auxiliary lid respectively provides a breach for inserting the protrusions while the locating piece is inserted in the locating hole.

14. The cover plate of the projector of claim 1, wherein the hook member is protruded on a surface of the auxiliary lid and has a L-shaped bending.

15. The cover plate of the projector of claim 14, wherein the lock portion has a trough structure depressed in a surface of the main lid, a side wall of the trough structure provides a split for the L-shaped bending to pass through.

16. The cover plate of the projector of claim 15, wherein the trough structure has a protruding rail on the bottom thereof.

17. A projector, comprising:
a light emitting element;
a case for placing the light emitting element;
a main lid, assembled with the case, and having a lock portion and a window portion, wherein the window portion is disposed at a position corresponding to the light emitting element;
a pivot member, connected with the main lid; and
an auxiliary lid, having a side portion connected to the pivot member, wherein the auxiliary lid is opened by lifting relative to the main lid by means of the pivot member, so as to cover the window portion selectively, and the auxiliary lid has a hook member disposed to correspond to the lock portion and has a displacement parallel and relative to the main lid by means of the pivot member when the auxiliary lid covers the window portion, so that the hook member is locked by the lock portion selectively.

18. The projector of claim 17, wherein the pivot member includes a base and a hollow retaining ring, respectively connected to the main lid and the auxiliary lid, the base has a shaft which is movably fastened to the hollow retaining ring.

19. The projector of claim 18, wherein the hollow retaining ring has a rail structure, which includes a first protruding point and a second protruding point, so that the shaft is capable of moving in the rail structure, and is fixed at a first position by the first protruding point, or fixed at a second position by the second protruding point.

20. The projector of claim 19, wherein the rail structure has two opposite inside walls, which have two opposite first protruding points and two opposite second protruding points, each of the first protruding points is protruded on one of the opposite inside walls, and each of the second protruding points is protruded on one of the opposite inside walls.

21. The projector of claim 20, wherein a distance between the two opposite first protruding points is smaller than a diameter of the shaft, and a distance between the two opposite second protruding points is smaller than a diameter of the shaft.

22. The projector of claim 18, wherein a surface of the shaft has a plurality of ribs.

23. The projector of claim 18, wherein the main lid provides a concave portion located at an edge thereof, and the concave portion and the base are respectively disposed at two opposite sides of the window portion.

24. The projector of claim 18, wherein the main lid provides an opening located at a side of the base, and the auxiliary further has a protrusion passing through the opening, the protrusion is moved to touch a first wall of the opening when the auxiliary lid is lifted until substantially vertical to the main lid.

25. The projector of claim 24, wherein a second wall of the opening is formed as a stop piece, which protrudes toward an inside of the opening, and the protrusion is limited to move between the stop piece and the first wall of the opening when the auxiliary lid is lifted until substantially vertical to the main lid.

26. The projector of claim 17, wherein the auxiliary lid has a locating piece protruding from an edge thereof, and the main lid has a locating hole for the locating piece inserting along a direction parallel to a surface of the main lid.

27. The projector of claim 26, wherein the main lid includes a molding corresponding to the edge of the auxiliary lid, two ends of the molding respectively have a protrusion, and two ends of the edge of the auxiliary lid respectively provides a breach for inserting the protrusions while the locating piece is inserted the locating hole.
